(19) United States
(12) Patent Application Publication
(10) Pub. No.: US 2015/0293425 A1
(43) Pub. Date: Oct. 15, 2015

(54) ELECTROPHORETIC DEVICE AND DISPLAY UNIT

(71) Applicant: SONY CORPORATION, Minato-ku, Tokyo (JP)

(72) Inventors: Yuriko Kaino, Kanagawa (JP); Ken Kobayashi, Kanagawa (JP); Aya Shuto, Kanagawa (JP); Hidehiko Takanashi, Kanagawa (JP); Masakazu Mitsugi, Kanagawa (JP); Atsuhito Yasui, Kanagawa (JP)

(73) Assignee: Sony Corporation, Tokyo (JP)

(21) Appl. No.: 14/646,057

(22) PCT Filed: Nov. 19, 2013
(86) PCT No.: PCT/JP2013/006766

§ 371 Date: May 20, 2015

(30) Foreign Application Priority Data
Nov. 27, 2012 (JP) 2012-258543

(51) Int. Cl. G02F 1/167; G02F 1/01

(52) U.S. Cl. CPC G02F 1/167; G02F 1/0121

(57) ABSTRACT

The present disclosure relates to a display apparatus that includes a first layer (30A) and a second layer (30B) disposed adjacent one another. The index of refraction of the second layer (30B) may be different from the index of refraction of the first layer (30A). The apparatus further includes a plurality of electrophoretic particles (20) associated with at least one of the first layer (30A) and the second layer (30B). The present disclosure also relates to a method of manufacturing a display apparatus, including positioning a first layer (30A) adjacent to a second layer (30B). A plurality of electrophoretic particles (20) is positioned within at least one of the first layer (30A) and the second layer (30B). The display apparatus is operated by applying an electric field to cause movement of a plurality of electrophoretic particles (20) through the first layer (30A) toward the second layer (30B).

### TECHNICAL FIELD

The present disclosure relates to an electrophoretic device including a plurality of electrophoretic particles in an insulating liquid and to a display unit including the same.

### BACKGROUND ART

In recent years, as mobile devices represented by mobile phones and personal digital assistants become widely used, display units (displays) with low power consumption and high image quality have been increasingly demanded. In particular, lately, in association with birth of delivery business of electronic books, personal digital assistants (electronic book terminals) for the purpose of reading textual information for a long time have attracted attentions. Therefore, displays having display quality suitable for such a reading purpose have been desired.

Cholesteric liquid crystal displays, electrophoretic displays, electrochromic displays, twist ball displays, and the like have been proposed as the display for reading. In particular, reflective displays are preferable. Since the reflective displays perform light display by utilizing reflection (scattering) of outside light as paper does, the reflective displays provide display quality close to that of paper. Further, in the reflective displays, a back-light is not necessitated, and therefore, power consumption is kept low.

A major candidate of the reflective displays is the electrophoretic display that generates contrast by utilizing electrophoretic phenomenon, since power consumption is low and high-speed response is superior in the electrophoretic display. Therefore, various discussions have been made for display methods of the electrophoretic display.

For example, a display unit in which two types of charged particles each having different optical characteristics are used, one thereof is dispersed in an insulating liquid, and the other thereof is retained in a porous layer arranged in the insulating liquid has been disclosed (for example, see PTL 1). In this display unit, display switching is performed by moving the charged particles dispersed in the insulating liquid through fine pores of the porous layer according to an electric field.

### CITATION LIST

### Patent Literature

### PTL 1: JP 2012-022296A

### SUMMARY

### Technical Problem

Although various display methods of the electrophoretic display have been proposed, the display quality thereof is not enough yet. In view of achieving color display, video display, and the like in the future, further improvement of display characteristics is desired, and more specifically, improvement of contrast is desired.

It is desirable to provide an electrophoretic device capable of improving contrast and a display unit including the same.

### Solution to Problem

In an illustrative embodiment, a display apparatus is provided The apparatus includes a first layer, having a first index of refraction; a second layer, having a second index of refraction, disposed adjacent to the first layer, the second index of refraction being different than the first index of refraction; and a plurality of electrophoretic particles associated with at least one of the first layer and the second layer.

In another illustrative embodiment, a method of manufacturing a display apparatus is provided. The method includes positioning a first layer, having a first index of refraction, adjacent to a second layer, having a second index of refraction, the second index of refraction being different than the first index of refraction; and positioning a plurality of electrophoretic particles within at least one of the first layer and the second layer.

In a further illustrative embodiment, a method of operating a display apparatus is provided. The method includes applying an electric field to cause movement of a plurality of electrophoretic particles through a first layer, having a first index of refraction, toward a second layer, having a second index of refraction, the second index of refraction being different than the first index of refraction.

### Advantageous Effects of Invention

According to the electrophoretic device and the display unit of the above-described embodiments of the present technology, the porous layer includes the plurality of layers that have different refractive indices. Therefore, display shielding of the electrophoretic particles by the porous layer is decreased, and contrast is improved. Accordingly, a high-quality display unit with improved display characteristics is allowed to be provided.

It is to be understood that both the foregoing general description and the following detailed description are exemplary, and are intended to provide further explanation of the technology as claimed.

### BRIEF DESCRIPTION OF DRAWINGS

FIG. 1A is a plan view illustrating a configuration of an electrophoretic device according to an embodiment of the present technology.

FIG. 1B is a cross-sectional view illustrating a configuration of the electrophoretic device illustrated in FIG. 1A.

FIG. 2A is a cross-sectional view illustrating an example of an electrophoretic device in a related art of the embodiment of the present technology.

FIG. 2B is a plan view of a side of a display surface of the electrophoretic device illustrated in FIG. 2A.

FIG. 3A is a cross-sectional view illustrating an example of the electrophoretic device illustrated in FIGS. 1A and 1B.

FIG. 3B is a plan view of a side of a display surface of the electrophoretic device illustrated in FIG. 3A.

FIG. 4A is a cross-sectional view illustrating another example of the electrophoretic device in the embodiment of the present technology.

FIG. 4B is a cross-sectional view illustrating another example of the electrophoretic device illustrated in FIG. 4A.

FIG. 5 is a cross-sectional view illustrating a configuration of an electrophoretic device according to a modification of the embodiment of the present technology.

FIG. 6A is a cross-sectional view illustrating another example of the electrophoretic device in the modification.

FIG. 6B is a cross-sectional view illustrating another example of the electrophoretic device illustrated in FIG. 6A.

FIG. 7 is a cross-sectional view illustrating a configuration of a display unit using the electrophoretic device according to the embodiment of the present technology.

FIG. 8 is a cross sectional view for explaining operation of the display unit illustrated in FIG. 7.

### DESCRIPTION OF EMBODIMENT

An embodiment of the present technology will be described in detail with reference to the drawings. The description will be given in the following order:

1. Embodiment (an example in which porous low-refractive index layers are arranged with a high-refractive index layer in between as a porous layer)

1-1. Whole Configuration

1-2. Method of Forming Porous Layer

1-3. Function and Effect

2. Modification (an example in which a continuous film is provided as a low-refractive index layer)

3. Application Example

4. Examples

### 1. ELECTROPHORETIC DEVICE

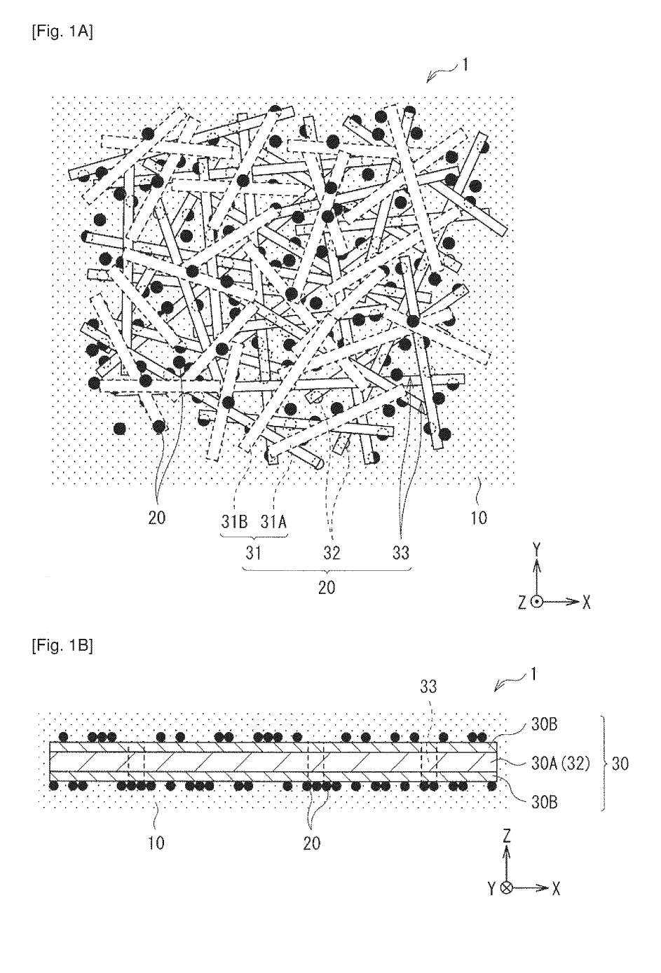

FIG. 1A and FIG. 1B respectively illustrate a plane configuration (FIG. 1A) and a cross-sectional configuration (FIG. 1B) of an electrophoretic device 1 according to an embodiment of the present technology. The electrophoretic device 1 generates contrast by utilizing electrophoretic phenomenon, and may be applied to various electronic apparatuses such as a display unit. The electrophoretic device 1 includes a plurality of electrophoretic particles 20 having polarity and a porous layer 30 in an insulating liquid 10. In this embodiment, the porous layer 30 is configured of a plurality of layers each having different optical characteristics.

### (1-1. Whole Configuration)

### (Insulating Liquid)

The insulating liquid 10 may be, for example, one or more of organic solvents, and may be specifically paraffin, isoparaffin, or the like. The viscosity and the refractive index of the insulating liquid 10 may be preferably small as much as possible. One reason for this is that, in this case, mobility (response speed) of the electrophoretic particles 20 is improved, and accordingly, energy (power consumption) necessary to move the electrophoretic particles 20 is decreased. Another reason for this is that, since a difference between the refractive index of the insulating liquid 10 and the refractive index of the porous layer 30 (specifically, a high-refractive index layer 30A) is increased, the refractive index of the porous layer 30 is increased.

It is to be noted that the insulating liquid 10 may contain various materials as necessary. Examples of the various materials may include a colorant, a charge-controlling agent, a dispersion stabilizer, a viscosity modifier, a surfactant, and a resin.

(Electrophoretic Particles)

The electrophoretic particles 20 are charged particles dispersed in the insulating liquid 10, and are movable through the porous layer 30 according to an electric field. The electrophoretic particles 20 are one or more of particles (powder) formed of a material such as an organic pigment, an inorganic pigment, a dye, a carbon material, a metal material, a metal oxide, glass, and a polymer material (resin). Further, the electrophoretic particle 20 may be a crushed particle, a capsule particle, or the like of a resin solid content containing the foregoing particles. It is to be noted that materials corresponding to the carbon material, the metal material, the metal oxide, the glass, or the polymer material are excluded from materials corresponding to the organic pigment, the inorganic pigment, or the dye.

Examples of the organic pigment may include an azo pigment, a metal complex azo pigment, a poly-condensed azo pigment, a flavanthrone pigment, a benzimidazolone pigment, a phthalocyanine pigment, a quinacridone pigment, an anthraquinone pigment, a perylene pigment, a perinone pigment, an anthrapyridine pigment, a piranthrone pigment, a dioxazine pigment, a thioindigo pigment, an isoindolinone pigment, a quinophthalone pigment, and an indanthrene pigment. Examples of the inorganic pigment may include zinc oxide, antimony trioxide, carbon black, iron black, titanium boride, colcothar, mapico yellow, minium, cadmium yellow, zinc sulfide, lithopone, barium sulfide, cadmium selenide, calcium carbonate, barium sulfate, lead chromate, lead sulfate, barium carbonate, white lead, and alumina white. Examples of the dye may include a nigrosine dye, an azo dye, a phthalocyanine dye, a quinophthalone dye, an anthraquinone dye, and a methine dye. Examples of the carbon material may include carbon black. Examples of the metal material may include gold, silver, and copper. Examples of the metal oxide may include titanium oxide, zinc oxide, zirconium oxide, barium titanate, potassium titanate, copper-chromium oxide, copper-manganese oxide, copper-iron-manganese oxide, copper-chromium-manganese oxide, and copper-iron-chromium oxide. Examples of the polymer material may include a polymer compound in which a functional group having a light absorption region in a visible light region is introduced. As long as such a polymer compound having the light absorption region in the visible light region is used, the type thereof is not particularly limited.

The content (concentration) of the electrophoretic particles 20 in the insulating liquid 10 is not particularly limited, and may be preferably, for example, from 0.1 wt % to 10 wt % both inclusive, since thereby, shielding characteristics and mobility of the electrophoretic particles 20 are secured. In this case, if the content (concentration) of the electrophoretic particles 20 in the insulating liquid 10 is smaller than 0.1 wt %, the electrophoretic particles 20 may be less likely to shield the porous layer 30. On the other hand, if the content (concentration) of the electrophoretic particles 20 in the insulating liquid 10 is larger than 10 wt %, dispersibility of the electrophoretic particles 20 is lowered, and therefore, the electrophoretic particles 20 may be less likely to be electrophoresed, and may be aggregated in some cases.

The electrophoretic particles 20 have any optical reflection characteristics (light reflectance). Although the optical reflection characteristics of the electrophoretic particles 20 are not particularly limited, at least, it is preferable that the electrophoretic particles 20 be allowed to shield the porous layer 30. One reason for this is that, by using a difference between the optical characteristics of the electrophoretic particles 20 and the optical characteristics of the porous layer 30, contrast is generated.

Specific formation materials of the electrophoretic particles 20 are selected according to a role undertaken by the electrophoretic particles 20 to generate contrast. Specifically, a material in the case of performing light display by the electrophoretic particles 20 may be, for example, a metal oxide such as titanium oxide, zinc oxide, zirconium oxide, barium titanate, and potassium titanate; an inorganic salt such as barium sulfate and calcium carbonate; an organic compound such as a bisstyryl derivative (for example, see JP H11-130975A) and polyvinyl naphthalene fine particles; hollow fine particles; or the like. On the other hand, a material in the case of performing dark display by the electrophoretic particles 20 may be, for example, a carbon material, a metal oxide, or the like. Examples of the carbon material may include carbon black. Examples of the metal oxide may include copper-chromium oxide, copper-manganese oxide, copper-iron-manganese oxide, copper-chromium-manganese oxide, and copper-iron-chromium oxide.

In the case of performing the light display by the electrophoretic particles 20, a color of the electrophoretic particles 20 viewed when the electrophoretic device 1 is seen from outside is not particularly limited as long as contrast is allowed to be thereby generated. However, in particular, the color of the electrophoretic particles 20 in this case may be preferably a color close to white, and may be more preferably white. On the other hand, in the case of performing the dark display by the electrophoretic particles 20, the color of the electrophoretic particles 20 viewed when the electrophoretic device 1 is seen from outside is not particularly limited as long as contrast is allowed to be thereby generated. However, in particular, the color of the electrophoretic particles 20 in this case may be preferably a color close to black, and may be more preferably black. In both cases, high contrast is obtainable.

It is preferable that the electrophoretic particles 20 be easily dispersed and be easily charged in the insulating liquid 10 for a long time, and be less likely to be absorbed into the porous layer 30. Therefore, a disperser (or a charge adjuster) may be used to disperse the electrophoretic particles 20 by electrostatic repulsion, the electrophoretic particles 20 may be subject to surface treatment, or both the foregoing methods may be used.

Examples of the disperser may include Solsperse series available from Lubrizol Co., BYK series or Anti-Terra series available from BYK-Chemie Co., and Span series available from ICI Americas Co.

Examples of the surface treatment may include rosin treatment, surfactant treatment, pigment derivative treatment, coupling agent treatment, graft polymerization treatment, and microcapsulation treatment. In particular, the graft polymerization treatment, the microcapsulation treatment, or a combination thereof may be preferable, since thereby dispersion stability and the like are obtainable for a long time.

Examples of a material for the surface treatment may include a material (absorptive material) having a functional group capable of being absorbed into the surface of the electrophoretic particles 20 and a polymerizable functional group. Absorbable functional group type is determined according to the formation material of the electrophoretic particles 20. Examples thereof may include an aniline derivative such as 4-vinylaniline for a carbon material such as carbon black and an organosilane derivative such as methacrylic acid 3-(trimethoxysilyl)propyl for a metal oxide. Examples of the polymerizable functional group may include a vinyl group, an acryl group, and a methacryl group.

Further, examples of the material for the surface treatment may include a material (graft material) capable of being grafted into the surface of the electrophoretic particles 20 to which a polymerizable functional group is introduced. The graft material may preferably have a polymerizable functional group and a dispersion functional group capable of dispersing the electrophoretic particles 20 in the insulating liquid 10 and capable of retaining dispersibility by steric barrier. Polymerizable functional group type is similar to that described for the absorptive material. Examples of the dispersion functional group may include a branch-like alkyl group in the case where the insulating liquid 10 is paraffin. To polymerize or graft the graft material, for example, a polymerization initiator such as azobisisobutyronitrile (AIBN) may be used.

For reference, for details of the method of dispersing the electrophoretic particles 20 in the insulating liquid 10 as described above, descriptions are given in books such as “Dispersion Technology of Superfine Particle and Evaluation thereof: Surface Treatment, Pulverizing, and Dispersion Stabilization in Air/Liquid/Polymer” published by Science & Technology Co.

(Porous Layer)

The porous layer 30 is a three-dimensional space structure configured of a plurality of layers each having different optical characteristics as described above. That is, the porous layer 30 has a multilayer structure, and is configured of the high-refractive index layer 30A having reflectance different from that of the electrophoretic particles 20 and a low-refractive index layer 30B having a refractive index lower than that of the high-refractive index layer 30A. Specifically, the porous layer 30 has a structure in which two low-refractive index layers 30B are arranged respectively on the display surface side and the rear surface side with the high-refractive index layer 30A in between. The high-refractive index layer 30A and the low-refractive index layer 30B are respectively formed of fibrous structures 31 (31A and 31B), and respectively have a plurality of fine pores 33.

(High-Refractive Index Layer)

Regarding the high-refractive index layer 30A, the fibrous structure 31A includes a plurality of non-electrophoretic particles 32. That is, the plurality of non-electrophoretic particles 32 are supported by the fibrous structure 31A. In the high-refractive index layer 30A as the three-dimensional space structure, one fibrous structure 31A may be intertwined at random, a plurality of fibrous structures 31A may assemble and be layered at random, or both the foregoing states may exist at once. In the case where the plurality of fibrous structures 31A exist, the respective fibrous structures 31A support one or more non-electrophoretic particles 32. It is to be noted that FIG. 1A illustrates a case that the porous high-refractive index layer 30A is formed of the plurality of fibrous structures 31A.

One reason why the high-refractive index layer 30A is the three-dimensional space structure formed of the fibrous structure 31A is that, in this case, light (outside light) is reflected diffusely, and the refractive index of the high-refractive index layer 30A is increased. Thereby, the thickness of the high-refractive index layer 30A is allowed to be decreased. Accordingly, contrast of the electrophoretic device 1 is increased, and energy necessary to move the electrophoretic particles 20 is decreased.

One reason why the fibrous structure 31A includes the plurality of non-electrophoretic particles 32 is that, in this case, light is more easily reflected diffusely, and the reflectance of the high-refractive index layer 30A is further increased. Thereby, contrast of the electrophoretic device 1 is further increased. Further, since the high-refractive index layer 30A has the three-dimensional space structure formed of the fibrous structure 31A, light (outside light) is reflected diffusely (multiply scattered), and therefore, higher reflectance is obtained.

The fibrous structure 31A may be, for example, formed of one or more of a polymer material, an inorganic material, and the like, and may be formed of other materials. Examples of the polymer material may include nylon, polyactic acid, polyamide, polyimide, polyethylene terephthalate, polyacrylonitrile, polyethylene oxide, polyvinyl carbazole, polyvinyl chloride, polyurethane, polystyrene, polyvinyl alcohol, polysulfone, polyvinyl pyrrolidone, polyvinylidene fluoride, polyhexafluoropropylene, polymethacrylic acid esters (such as polymethacrylic acid methyl), polyacrylic esters (such as polyacrylic ethylhexyl), acetylcellulose, collagen, gelatin, chitosan, and copolymers thereof. Examples of the inorganic material may include titanium oxide. In particular, as a formation material of the fibrous structure 31A, the polymer material may be preferable. Since the polymer material has low reactivity (photoreactivity or the like), that is, the polymer material is chemically stable, unintended decomposition reaction of the fibrous structure 31A is thereby suppressed. It is to be noted that, in the case where the fibrous structure 31A is formed of a material with high reactivity, the surface of the fibrous structure 31A may be preferably covered with any protective layer (not illustrated).

The shape (appearance) of the fibrous structure 31A is not particularly limited as long as the fibrous structure 31A is a fiber having a sufficiently large length with respect to the fiber diameter as described above. Specifically, the shape (appearance) thereof may be linear, may be curly, or may be bent on the way. Further, the fibrous structure 31A may be extended in one direction, or may be branched into two or more directions on the way. A method of forming the fibrous structure 31A is not particularly limited. The method of forming the fibrous structure 31A may be preferably, for example, a phase separation method, a phase reverse method, an electrostatic (electric field) spinning method, a melt spinning method, a wet spinning method, a dry spinning method, a gel spinning method, a sol gel method, a spray coating method, or the like, since a fibrous material having a sufficiently large length with respect to the fiber diameter is easily and stably formed by the foregoing methods.

Although the average fiber diameter of the fibrous structure 31A is not particularly limited, the average fiber diameter thereof is preferably small as much as possible. One reason for this is that, in this case, light becomes easily reflected diffusely, and the pore diameter of the fine pore 33 becomes larger. However, it may be necessary to determine the average fiber diameter (diameter) of the fibrous structure 31A so that the fibrous structure 31A is allowed to support the after-mentioned non-electrophoretic particles 32. Therefore, the average fiber diameter of the fibrous structure 31A may be preferably equal to or less than 10 micrometers. It is to be noted that the lower limit of the average fiber diameter is not particularly limited, and may be, for example, equal to or less than 0.1 micrometers. The average fiber diameter may be, for example, measured by microscope observation with the use of a scanning electron microscope or the like. It is to be noted that the average length of the fibrous structure 31A may be set optionally.

In particular, the fibrous structure 31A may be preferably a nanofiber. One reason for this is that, in this case, light becomes easily reflected diffusely, and therefore, the refractive index of the high-refractive index layer 30A is further increased. Another reason for this is that, in this case, a rate of the fine pores 33 per unit volume is increased, and therefore, the electrophoretic particles 20 easily move through the fine pores 33. Thereby, contrast is further increased, and the energy necessary to move the electrophoretic particles 20 is further decreased. The nanofiber is a fibrous material having a fiber diameter being from 0.001 micrometers to 0.1 micrometers both inclusive and having a length being 100 times or more the fiber diameter. The fibrous structure 31A as the nanofiber may be preferably formed by an electrostatic spinning method, since thereby, the fibrous structure 31A having a small fiber diameter is easily and stably formed.

The fibrous structure 31A may preferably have optical characteristics different from those of the electrophoretic particles 20. Specifically, although the optical characteristics of the fibrous structure 31A are not particularly limited, the optical characteristics thereof may be preferably set at least so that the high-refractive index layer 30A is allowed to shield the electrophoretic particles 20 as a whole. One reason for this is that, as described above, in this case, by using the difference between the optical characteristics of the electrophoretic particles 20 and the optical characteristics of the high-refractive index layer 30A, contrast is allowed to be generated. Accordingly, the fibrous structure 31A having light transparency (transparent and colorless characteristics) in the insulating liquid 10 may not be preferable. However, in the case where the optical characteristics of the fibrous structure 30A are less likely to affect the optical characteristics of the high-refractive index layer 30A, and the optical characteristics of the high-refractive index layer 30A are substantially determined by the optical characteristics of the non-electrophoretic particles 32, the optical characteristics of the fibrous structure 31A may be set optionally.

Although the average pore diameter of the fine pores 33 is not particularly limited, the average pore diameter thereof may be preferably large as much as possible, since the electrophoretic particles 20 easily move through the fine pores 33 thereby. Therefore, the average pore diameter of the fine pores 33 may be preferably from 0.01 micrometers to 10 micrometers both inclusive.

The thickness of the high-refractive index layer 30A is not particularly limited, and may be, for example, from 5 micrometers to 100 micrometers both inclusive, since shielding characteristics of the high-refractive index layer 30A are increased thereby, and the electrophoretic particles 20 easily move through the fine pores 33.

Although the polarity of the fibrous structure 31A is not particularly limited, the fibrous structure 31A may have, for example, the same polarity as that of the electrophoretic particles 20. For example, a polymer material having desired polarity may be preferably used. Modification may be made on the surface of the fibrous structure 31A with the use of a functional group having the same polarity as that of the electrophoretic particles 20. Alternatively, a chemical material showing the same polarity may be added. In the electrophoretic device 1 utilizing electrophoretic phenomenon as in this embodiment, contrast is generated by a difference between the optical characteristics of the electrophoretic particles 20 and the optical characteristics of the high-refractive index layer 30A. Specifically, in the case where an electric field is applied to the electrophoretic device 1, the electrophoretic particles 20 are moved through the fine pores 33 formed by the fibrous structure 31A in a range in which the electric field is applied, and thereby, switching is made between light display and dark display. The electrophoretic particles 20 are charged particles with polarity, and a functional group having acceptor characteristics or donor characteristics is bonded to the surface of the electrophoretic particles 20. Therefore, in the case where the fibrous structure 31A has polarity opposite to that of the electrophoretic particles 20, when the electrophoretic particles 20 pass through the fine pores 33, absorption or movement thereof may be suppressed, and display characteristics may be lowered. On the other hand, for example, by adding a functional group having the same polarity as that of the electrophoretic particles 20 to the surface of the fibrous structure 31A, absorption of the electrophoretic particles 20 in the fine pores 33 is suppressed.

A functional group modified on the surface of the fibrous structure 31A is not particularly limited as long as the functional group has the same polarity as that of the electrophoretic particles 20. Preferable examples thereof may include an amine-based functional group (an amino group, an imino group, and an amide group), a silicon atom (Si), a titanium atom, an aluminum atom, siloxane (—Si—O—), titanate (—Ti—O—), and aluminate (—Al—O—). Although types of bonding between the fibrous structure 31A and the foregoing functional group is not particularly limited, covalent bonding may be preferable. As described above, since the electrophoretic particles 20 are moved through the fine pores 33 formed by the fibrous structure 31A, the electrophoretic particles 20 may be in contact with the fibrous structure 31A. Therefore, in the case where bonding force between the fibrous structure 31A and the foregoing functional group is weak, the foregoing functional group may be detached from the fibrous structure 31A.

Although a modification method of the fibrous structure 31A, that is, a surface treatment method thereof is not particularly limited, the modification process may be preferably performed under moderate conditions. For example, vapor-phase reaction using a silane coupling agent may be preferably performed. One reason for this is that, in the electrophoretic device 1, gaps (fine pores 33) formed by the fibrous structure 31A and the structure thereof are important, and therefore, modification should be performed without changing the structure.

The non-electrophoretic particles 32 are supported by (fixed to) the fibrous structure 31A, and are particles that are not electrophoresed. A formation material of the non-electrophoretic particles 32 may be, for example, similar to the formation material of the electrophoretic particles 20, and is selected according to a role undertaken by the non-electrophoretic particles 32 described later.

It is to be noted that the non-electrophoretic particles 32 may be partially exposed from the fibrous structure 31A, or may be buried in the fibrous structure 31A, as long as the non-electrophoretic particles 32 are supported by the fibrous structure 31A.

The non-electrophoretic particles 32 have optical characteristics different from those of the electrophoretic particles 20. Although the optical characteristics of the non-electrophoretic particles 32 are not particularly limited, the optical characteristics thereof may be preferably set at least so that the high-refractive index layer 30A is allowed to shield the electrophoretic particles 20 as a whole. One reason for this is that, as described above, by using the difference between the optical characteristics of the electrophoretic particles 20 and the optical characteristics of the high-refractive index layer 30A, contrast is allowed to be generated.

The formation material of the non-electrophoretic particles 32 is selected according to the role undertaken by the non-electrophoretic particles 32 for generating contrast. Specifically, a material in the case of performing the light display by the non-electrophoretic particles 32 is similar to the material selected in the case of performing the light display by the electrophoretic particles 20. On the other hand, a material in the case of performing the dark display by the non-electrophoretic particles 32 is similar to the material selected in the case of performing the dark display by the electrophoretic particles 20. In particular, as the material selected in the case of performing the light display by the non-electrophoretic particles 32, a metal oxide may be preferable, since thereby, superior chemical stability, superior fixing characteristics, and superior light reflectance are obtainable. The formation material of the non-electrophoretic particles 32 may be the same type as that of the formation material of the electrophoretic particles 20, or may be different type from that of the formation material of the electrophoretic particles 20, as long as contrast is allowed to be thereby generated.

It is to be noted that a color viewed in the case of performing the light display or the dark display by the non-electrophoretic particles 32 is similar to the case described for the viewed color of the electrophoretic particles 20.

(Low-Refractive Index Layer)

The low-refractive index layer 30B is a porous layer as the foregoing high-refractive index layer 30A is, is a layer having a refractive index (such as a refractive index equal to or lower than 2) lower than that of the high-refractive index layer 30A, and has a refractive index equal to that of the insulating liquid 10. Specifically, a difference between the refractive index of the low-refractive index layer 30B and the refractive index of the insulating liquid 10 may be preferably a value equal to or less than 0.5, and may be more preferably a value equal to or less than 0.2. Thereby, the low-refractive index layer 30B in the insulating liquid 10 includes light transparency, and is colorless and transparent.

The low-refractive index layers 30B in this embodiment are formed of the fibrous structures 31B as described above, and are oppositely arranged with the high-refractive index layer 30A in between as illustrated in FIG. 1B. The shape (appearance) of the fibrous structure 31B is not particularly limited as long as the fibrous structure 31B is a fiber having a sufficiently large length with respect to the fiber diameter as the fibrous structure 31A forming the foregoing high-refractive index layer 30A is. Although the average fiber diameter of the fibrous structure 31B is not particularly limited as the foregoing average fiber diameter of the fibrous structure 31A is, the average fiber diameter thereof may be preferably small as much as possible. One reason for this is that, in this case, the pore diameter of the fine pore 33 becomes larger, and the electrophoretic particles 20 are easily retained in the fine pores 33 of the low-refractive index layers 30B.

For the average fiber diameter (diameter) of the fibrous structure 31B, differently from the fibrous structure 31A, it is not necessary to pay attention to retaining force of the non-electrophoretic particles 32, since the low-refractive index layer 30B does not include the non-electrophoretic particles 32. Specifically, the average fiber diameter of the fibrous structure 31B may be preferably from 0.05 micrometers to 10 micrometers both inclusive, and may be equal to or less than 0.05 micrometers. The average fiber diameter may be, for example, measured by microscope observation with the use of a scanning electron microscope or the like. It is to be noted that the average length of the fibrous structure 31B may be set optionally. As the fibrous structure 31A forming the high-refractive index layer 30A, the fibrous structure 31B may be formed of one or more of a polymer material, an inorganic material, and the like, and may be formed of other materials.

Although the thickness of the low-refractive index layer 30B is not particularly limited, the thickness of the low-refractive index layer 30B may be preferably, for example, from 1 micrometers to 30 micrometers both inclusive, since in this case, the electrophoretic particles 20 are allowed to be sufficiently retained by the low-refractive index layer 30B.

As described above, the porous layer 30 is configured of the high-refractive index layer 30A having reflectance different from that of the electrophoretic particles 20 and the low-refractive index layer 30B having a refractive index lower than that of the high-refractive index layer 30A. Further, the low-refractive index layers 30B are oppositely arranged with the high-refractive index layer 30A in between. Thereby, dark display and light display at the time of applying an electric field are improved, and contrast is improved.

Further, the low-refractive index layer 30B may preferably have higher affinity with the electrophoretic particles 20 than the high-refractive index layer 30A does. Specifically as the fibrous structure 31B, for example, a polymer material having polarity opposite to that of the electrophoretic particles 20 may be selected. Alternatively, modification may be made on the fibrous structure 31B with the use of a functional group having polarity opposite to that of the electrophoretic particles 20. It is to be noted that examples of the functional group type may include a hydroxyl group, a carboxyl group, a carbonyl group, a cyano group, a nitro group, an amino group, and a halogen group. The polymer material includes any of these functional groups.

As described above, by improving affinity of the low-refractive index layer 30B with the electrophoretic particles 20 (for example, by setting polarity of the low-refractive index layer 30B different from that of the electrophoretic particles 20), diffusion of the electrophoretic particles 20 after deleting an electric field is suppressed. That is, memory characteristics are improved.

### (1-2. Method of Forming Porous Layer)

An example of formation procedure of the porous layer 30 is as follows. First, as step S101 (preparation of a polymer solution), a polymer material is dissolved in an organic solvent such as N,N′-dimethylformamide (DMF) to prepare a polymer solution, which is divided into two (two solutions A and B). Subsequently, as step S102 (dispersion of non-electrophoretic particles), the non-electrophoretic particles 32 (such as titanium oxide) are added to one of the polymer solutions (such as the solution B), the resultant is subsequently stirred sufficiently to disperse the non-electrophoretic particles 32, and thereby, a solution C is prepared. Next, as step S103 (spinning), first, spinning is performed by an electrostatic spinning method with the use of the solution A to form the fibrous structure 31B (the low-refractive index layer 30B). Subsequently, as in the case of using the solution A, spinning is performed on the fibrous structure 31B with the use of the solution C to form the fibrous structure 31A (the high-refractive index layer 30A). Next, spinning is performed on the fibrous structure 31A with the use of the solution A again to form the fibrous structure 31B. Thereby, the porous layer 30 of this embodiment in which the low-refractive index layers 30B are provided on both surfaces of the high-refractive index layer 30A is obtained.

(Preferable Display Method of Electrophoretic Device)

In the electrophoretic device 1 in this embodiment, as described above, the electrophoretic particles 20 and the high-refractive index layer 30A (the fibrous structure 31A containing the non-electrophoretic particles 32) respectively perform the light display and the dark display, and therefore, contrast is generated. In this case, it is possible that the light display is performed by the electrophoretic particles 20 and the dark display is performed by the high-refractive index layer 30A, or vice versa. Such a difference in roles is determined by relation between the optical characteristics of the electrophoretic particles 20 and the optical characteristics of the high-refractive index layer 30A.

In particular, it is preferable that the dark display be performed by the electrophoretic particles 20 and the light display be performed by the high-refractive index layer 30A. Accordingly, in the case where the optical characteristics of the high-refractive index layer 30A are substantially determined by the optical characteristics of the non-electrophoretic particles 32, the refractive index of the non-electrophoretic particles 32 may be preferably higher than the refractive index of the electrophoretic particles 20. The refractive index for the light display in this case becomes significantly increased by utilizing diffuse reflection of light by the high-refractive index layer 30A (three-dimensional space structure of the fibrous structure 31A), and therefore, contrast becomes significantly increased accordingly.

(Operation of Electrophoretic Device)

In the electrophoretic device 1, the optical characteristics of the electrophoretic particles 20 are different from the optical characteristics of the high-refractive index layer 30A (non-electrophoretic particles 32) configuring the porous layer 30. In this case, in the case where an electric field is applied to the electrophoretic device 1, the electrophoretic particles 20 are moved through the fine pores 33 of the high-refractive index layer 30A in a range in which the electric field is applied. Thereby, if the electrophoretic device 1 is viewed from the side on which the electrophoretic particles 20 are moved, the dark display (or the light display) is performed by the electrophoretic particles 20 in a range in which the electrophoretic particles 20 are moved, and the light display (or the dark display) is performed by the high-refractive index layer 30A in a range in which the electrophoretic particles 20 are not moved. Thereby, contrast is generated.

(Function and Effect)

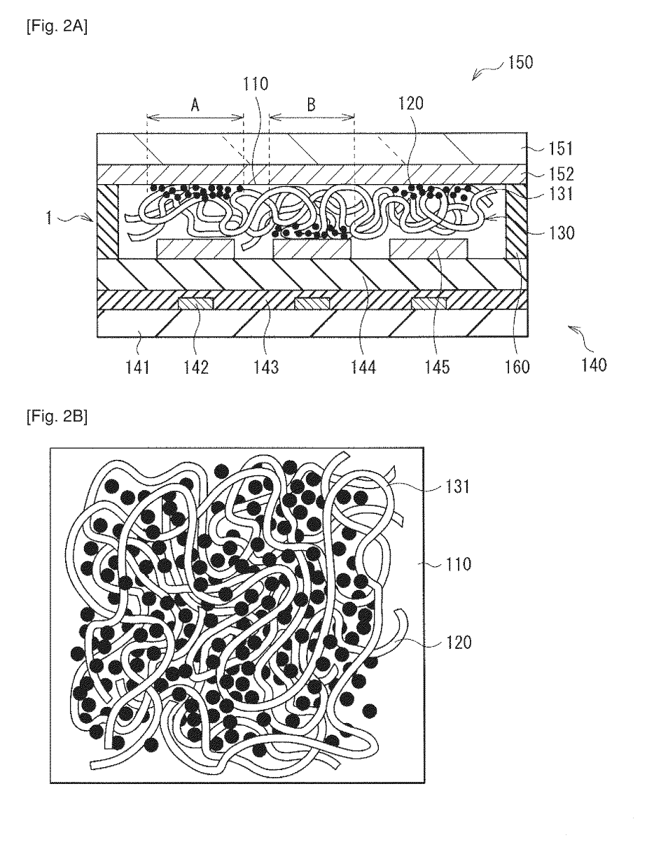

FIG. 2A illustrates a configuration of a display unit including an electrophoretic device 100 in which a porous layer 130 is configured of only the high-refractive index layer 30A in this embodiment. As in this embodiment and this display unit, in the electrophoretic device including charged particles (electrophoretic particles 20 or 120) and the porous layer (the high-refractive index layer 30A or the porous layer 130) having optical characteristics different from those of the charged particles, the electrophoretic particles 120 are moved to a side of a corresponding electrode (a pixel electrode 145 or an counter electrode 152) by applying an electric field. It is to be noted that a detailed configuration of the display unit will be described later.

FIG. 2B is a plan view viewed from the side of the counter electrode, that is, the side of a display surface S of a region A in which the electrophoretic particles 120 are moved to the side of the counter electrode 152, that is, dark display is performed. In the vicinity of the side of the display surface S in the region A, part of the fibrous structure 131 undertaking a role of light display is mixed with the electrophoretic particles 120 undertaking a role of dark display as illustrated in FIG. 2B. Therefore, the dark display (black reflectance) is lowered. Further, in a region B in which the electrophoretic particles 120 are moved to the side of the pixel electrode 145 (the side of a rear surface R), although not illustrated in the figure, part of the electrophoretic particles 120 is left in the fibrous structure 131, and thereby, white reflectance due to the fibrous structure 131 is lowered. That is, there has been a disadvantage of lowered contrast.

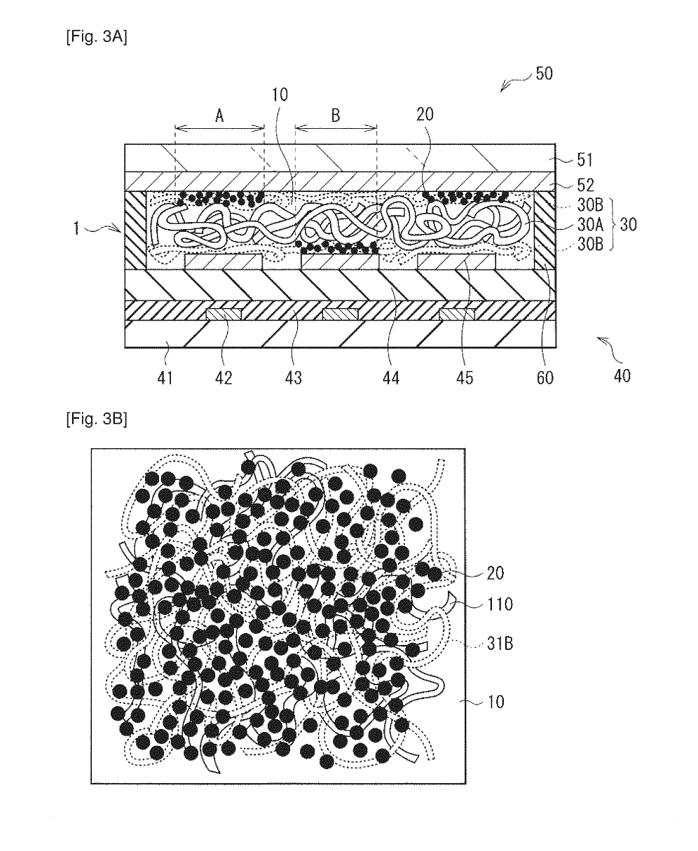

On the other hand, in the electrophoretic device 1 according to this embodiment, as in the display unit illustrated in FIG. 3A, the porous layer 30 is configured of the high-refractive index layer 30A formed of the fibrous structure 31A retaining the non-electrophoretic particles 32 and the low-refractive index layer 30B having a refractive index lower than that of the high-refractive index layer 30A. Specifically, the low-refractive index layers 30B are arranged both on the side of a pixel electrode 45 (the side of the rear surface R) and the side of a counter electrode 52 (the side of the display surface S) with the high-refractive index layer 30A in between. The low-refractive index layer 30B is formed of the fibrous structure 31B having a refractive index nearly equal to that of the insulating liquid 10, and is approximately transparent in the insulating liquid 10.

The electrophoretic particles 20 moved to a side of a corresponding electrode (the pixel electrode 45 or the counter electrode 52) by applying an electric field pass through the high-refractive index layer 30A and are contained in the fine pores 33 of the low-refractive index layer 30B. Further, the fibrous structure 31A configuring the high-refractive index layer 30A is prevented from moving to the vicinity of the pixel electrode 45 or the counter electrode 52 by the low-refractive index layer 30B arranged between the high-refractive index layer 30A and the electrode 42 and the low-refractive index layer 30B arranged between the high-refractive index layer 30A and the electrode 52. Therefore, in the region A in which the electrophoretic particles 20 are moved to the side of the counter electrode 52 (the side of the display surface), as illustrated in FIG. 3B, display is available without being shielded by the fibrous structure 31A of the high-refractive index layer 30A.

On the other hand, in the region B in which the electrophoretic particles 20 are moved to the side of the pixel electrode 45 (the side of the rear surface R), almost all the electrophoretic particles moved to the side of the pixel electrode 45 are contained in the low-refractive index layer 30B provided on the side of the pixel electrode 45. Therefore, although not illustrated here, in the region B viewed from the side of the display surface S, dark display (or light display) by the electrophoretic particles 20 is suppressed from being mixed with light display (or dark display) by the fibrous structure 31A (or the non-electrophoretic particles 32).

As described above, in this embodiment, the porous layer 30 performing light display (or dark display) is configured of two types of layers that are the high-refractive index layer 30A practically performing light display (or dark display) and the low-refractive index layer 30B having a refractive index lower than that of the high-refractive index layer 30A. In particular, two low-refractive index layers 30B are arranged oppositely with the high-refractive index layer 30A in between. Therefore, dark display (or light display) by the electrophoretic particles 20 on the side of the display surface is allowed to be suppressed from being shielded by the fibrous structure 31A (or the non-electrophoretic particles 32) performing light display (or dark display). Further, dark display (or light display) by the electrophoretic particles 20 is allowed to be suppressed from being mixed with light display (or dark display) by the fibrous structure 31A retaining the non-electrophoretic particles 32, that is, the high-refractive index layer 30A. Therefore, black reflectance is lowered, and white reflectance is improved. Accordingly, contrast is allowed to be improved.

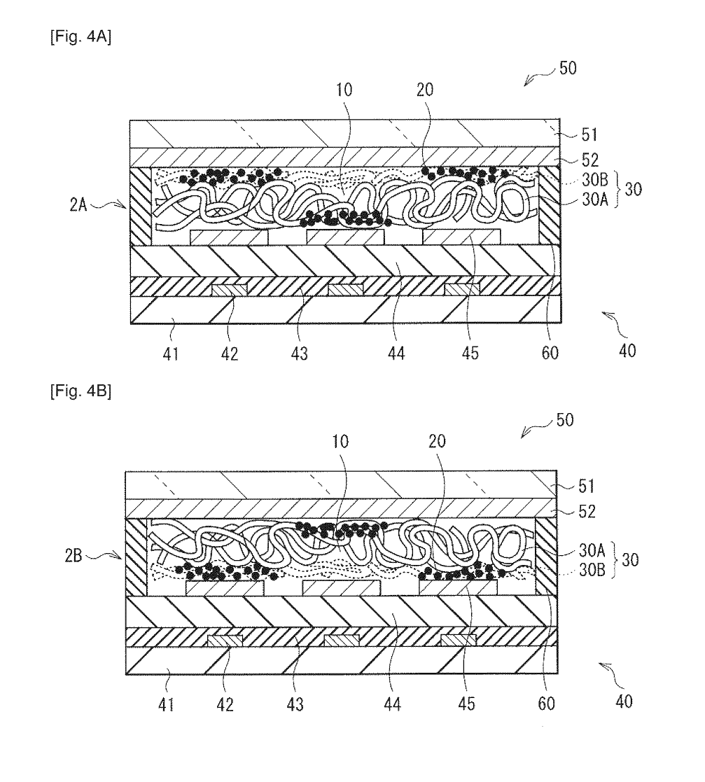

It is to be noted that, in this embodiment, the low-refractive index layers 30B are provided on both the side of the display surface S and the side of the rear surface R of the high-refractive index layer 30A. However, the low-refractive index layer 30B may be provided on either one of these surfaces. For example, the low-refractive index layer 30B may be provided only on the side of the display surface as an electrophoretic device 2A illustrated in FIG. 4A, or may be provided only on the side of the rear surface as an electrophoretic device 2B illustrated in FIG. 4B. However, the low-refractive index layer 30B may be preferably provided on the side of the display surface S, since contrast is improved thereby. The low-refractive index layers 30B may be more preferably provided on both the side of the display surface S and the side of the rear surface R as in this embodiment.

Further, in the case where the porous layer 30 has a three-layer structure as in this embodiment, when affinity between layers (the low-refractive index layers 30B in this embodiment) on the side of the display surface S and the side of the rear surface R and the electrophoretic particles 20 is high, diffusion of the electrophoretic particles 20 after deleting an electric field is suppressed. That is, memory characteristics are improved. The affinity between the low-refractive index layers 30B and the electrophoretic particles 20 is improved by using a polymer material having polarity opposite to that of the electrophoretic particles 20 for the low-refractive index layer 30B, or adding a functional group having opposite polarity thereto. It is to be noted that the porous layer 30 may have a two-layer structure. As illustrated in FIG. 4A and FIG. 4B, a layer (the low-refractive index layer 30B) having high affinity with the electrophoretic particles 20 may be provided on either one of the side of the display surface S and the side of the rear surface R.

### 2. MODIFICATION

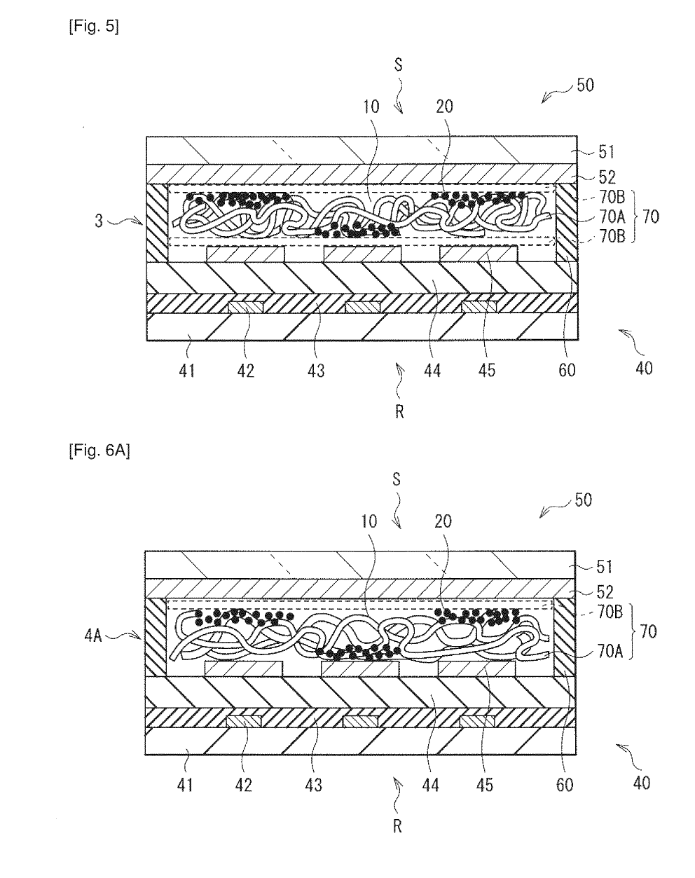

FIG. 5 illustrates a cross-sectional configuration of a display unit including an electrophoretic device 3 according to a modification of the embodiment of the present technology. The electrophoretic device 3 in this modification is configured of a plurality of layers (a high-refractive index layer 70A and a low-refractive index layer 70B) each having different optical characteristics as in the foregoing embodiment. However, this modification is different from the foregoing embodiment in that the low-refractive index layer 70B is a continuous film. It is to be noted that for the same components as those of the foregoing embodiment, the same referential symbols are affixed thereto, and descriptions thereof are omitted.

The low-refractive index layer 70B is a continuous film having optical characteristics different from those of the high-refractive index layer 70A. Specifically, the low-refractive index layer 70B has a lower refractive index than that of the high-refractive index layer 70A, and may have, for example, a refractive index nearly equal to that of the insulating liquid 10. As a material forming the low-refractive index layer 70B, a material similar to that of the low-refractive index layer 30B in the foregoing embodiment may be used. In this modification, the low-refractive index layer 70B may be formed by, for example, dissolving a material configuring the low-refractive index layer 30B in a solvent, and coating the pixel electrode 45 and the counter electrode 52 with the resultant.

Although the thickness of the low-refractive index layer 70B is not particularly limited, the thickness of the low-refractive index layer 70B may be, for example, from 0.01 micrometers to 10 micrometers both inclusive. The low-refractive index layer 70B may preferably have affinity with the electrophoretic particles 20. Specifically, as the low-refractive index layer 30B, the low-refractive index layer 70B may preferably have polarity (electric charge) opposite to polarity of the electrophoretic particles 20.

Even if the low-refractive index layer 70B is formed as a continuous film as in the electrophoretic device 3 in this modification, diffusion of the electrophoretic particles 20 after deleting an electric field is allowed to be suppressed, and memory characteristics are allowed to be improved.

Further, in this modification, the low-refractive index layers 70B are provided on both the side of the display surface S and the side of the rear surface R with the high-refractive index layer 70A in between. However, the low-refractive index layer 70B may be provided on either one of these surfaces. For example, the low-refractive index layer 70B may be provided only on the side of the display surface as an electrophoretic device 4A illustrated in FIG. 6A, or may be provided only on the side of the rear surface as an electrophoretic device 4B illustrated in FIG. 6B. However, in the case where the low-refractive index layers 70B are provided on both the side of the display surface S and the side of the rear surface R as in this modification, memory characteristics are improved most.

### 3. APPLICATION EXAMPLE OF ELECTROPHORETIC DEVICE

Next, a description will be given of an application example of the foregoing electrophoretic devices 1 to 4. The electrophoretic devices 1 to 4 are applicable to various electronic apparatuses, and types of the electronic apparatuses are not particularly limited. For example, each of the electrophoretic devices may be applied to a display unit.

(Whole Configuration of Display Unit)

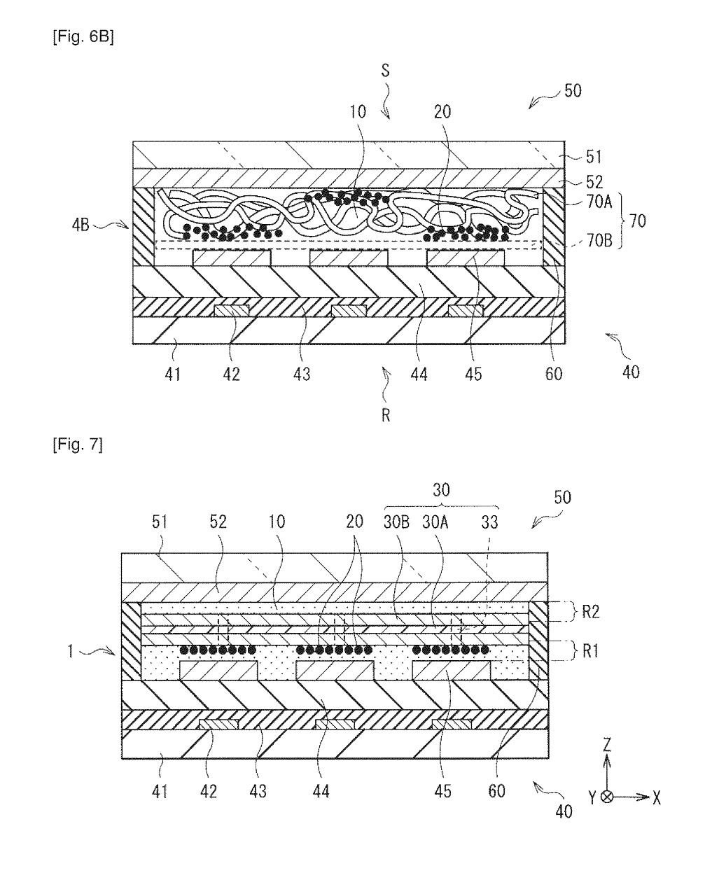

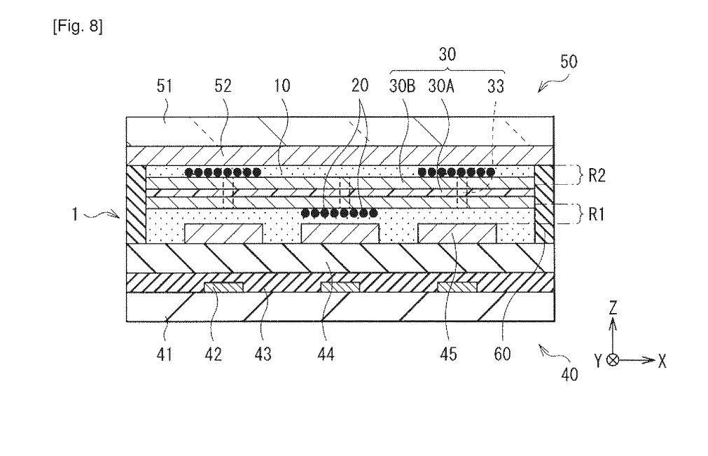

FIG. 7 illustrates a cross-sectional configuration of a display unit. FIG. 8 is a view for explaining operation of the display unit illustrated in FIG. 7. It is to be noted that the configuration of the display unit described below is merely an example, and may be changed as appropriate.

The display unit is an electrophoretic display (so-called electronic paper display) for displaying an image (such as textual information) by using electrophoretic phenomenon. In the display unit, for example, as illustrated in FIG. 7, a drive substrate 40 and an opposed substrate 50 are oppositely arranged with an electrophoretic device 150 in between. For example, in the display unit, an image is displayed on the side of the opposed substrate 50. It is to be noted that the drive substrate 40 and the opposed substrate 50 are separated by a spacer 60 at a prescribed interval.

(Drive Substrate)

In the drive substrate 40, for example, a plurality of thin film transistors (TFT) 42, a protective layer 43, a planarizing insulating layer 44, and a plurality of pixel electrodes 45 are formed in this order over one surface of a support base substance 41. The TFT 42 and the pixel electrode 45 are arranged in a state of matrix or in a state of segment according to a pixel pattern.

The support base substance 41 may be formed of, for example, an inorganic material, a metal material, a plastic material, or the like. Examples of the inorganic material may include silicon (Si), silicon oxide (SiOₓ), silicon nitride (SiNₓ), and aluminum oxide (AlOₓ). Examples of the silicon oxide may include glass and spin-on glass (SOG). Examples of the metal material may include aluminum (Al), nickel (Ni), and stainless steel. Examples of the plastic material may include polycarbonate (PC), polyethylene terephthalate (PET), polyethylene naphthalate (PEN), and polyethyl ether ketone (PEEK).

The support base substance 41 may be of a light transmissive type or a non-light transmissive type. Since an image is displayed on the side of the opposed substrate 50, the support base substance 41 is not necessarily of a light transmissive type. Further, the support base substance 41 may be a substrate having rigidity such as a wafer, or may be a thin layer glass, a film, or the like having flexibility. In particular, the latter type is preferable, since thereby, a flexible (bendable) display unit is allowed to be achieved.

The TFT 42 is a switching-use device for selecting a pixel. It is to be noted that the TFT 42 may be an inorganic TFT using an inorganic semiconductor layer as a channel layer, or may be an organic TFT using an organic semiconductor layer. The protective layer 43 and the planarizing insulating layer 44 may be formed of, for example, an insulating resin material such as polyimide. However, as long as the surface of the protective layer 43 is sufficiently flat, the planarizing insulating layer 44 may be omitted. The pixel electrode 45 may be formed of, for example, a metal material such as gold (Au), silver (Ag), and copper (Cu). The pixel electrode 45 is connected to the TFT 42 through a contact hole (not illustrated) provided in the protective layer 43 and the planarizing insulating layer 44.

### (Opposed Substrate)

In the opposed substrate 50, for example, a counter electrode 52 may be formed entirely to cover one surface of a support base substance 51. Alternatively, the counter electrode 52 may be arranged in a state of matrix or in a state of segment as the pixel electrode 32 may be.

The support base substance 51 is formed of a material similar to that of the support base substance 41, except that the support base substance 51 is of a light transmissive type. Since an image is displayed on the side of the opposed substrate 50, the support base substance 51 should be of a light transmissive type. The counter electrode 52 may be formed of, for example, a light transmissive conductive material (transparent electrode material) such as indium oxide-tin oxide (ITO), antimony oxide-tin oxide (ATO), fluorine-doped tin oxide (FTO), and aluminum-doped zinc oxide (AZO).

In the case where an image is displayed on the side of the opposed substrate 50, viewers view the electrophoretic device 150 through the counter electrode 52. Therefore, light transmission characteristics (transmittance) of the counter electrode 52 may be preferably high as much as possible, and may be, for example, equal to or higher than 80%. Further, electric resistance of the counter electrode 52 may be preferably low as much as possible, and for example, may be equal to or smaller than 100 ohm/square.

(Electrophoretic Device)

The electrophoretic device 150 has a configuration similar to that of the foregoing electrophoretic device 1. Specifically, the electrophoretic device 150 includes the plurality of electrophoretic particles 20 and the porous layer 30 having the plurality of fine pores 33 in the insulating liquid 10. The insulating liquid 10 is filled in a space between the drive substrate 40 and the opposed substrate 50. For example, the porous layer 30 may be supported by a spacer 60. The space filled with the insulating liquid 10 is divided into a refuge region R1 on the side close to the pixel electrode 45 and a movement region R2 on the side close to the counter electrode 52 with the porous layer 30 in between as a boundary. Configurations of the insulating liquid 10, the electrophoretic particles 20, and the porous layer 30 are respectively similar to the configurations of the insulating liquid 10, the electrophoretic particles 20, and the porous layer 30. It is to be noted that FIG. 7 and FIG. 8 illustrate only part of the fine pores 33 to simplify illustrated content.

### (Spacer)

The spacer 60 may be formed of, for example, an insulating material such as a polymer material.

Although a shape of the spacer 60 is not particularly limited, the shape of the spacer 60 may be preferably a shape that does not prevent movement of the electrophoretic particles 20 and is allowed to uniformly distribute the electrophoretic particles 20. For example, the shape of the spacer 60 may be a lattice-like shape. Further, although the thickness of the spacer 60 is not particularly limited, the thickness of the spacer 60 may be preferably small as much as possible in order to decrease power consumption, and may be, for example, from 10 micrometers to 100 micrometers both inclusive.

(Operation of Display Unit)

In the display unit, as illustrated in FIG. 7, in an initial state, the plurality of electrophoretic particles 20 are located in the refuge region R1. In this case, the electrophoretic particles 20 are shielded by the porous layer 30 in all pixels, and therefore, contrast is not generated (an image is not displayed) in the case where the electrophoretic device 150 is viewed from the side of the opposed substrate 50.

In the case where a pixel is selected by the TFT 42 and an electric field is applied between the pixel electrode 45 and the counter electrode 52, as illustrated in FIG. 7, the electrophoretic particles 152 are moved from the refuge region R1 toward the movement region R2 thorough the porous layer 30 (fine pores 33). In this case, since pixels in which the electrophoretic particles 20 are shielded by the porous layer 30 and pixels in which the electrophoretic particles 20 are not shielded by the porous layer 30 coexist, contrast is generated when the electrophoretic device 150 is viewed from the opposed substrate 50 side. Thereby, an image is displayed.

(Function and Effect of Display Unit)

According to the display unit, the electrophoretic device 150 has a configuration similar to that of the foregoing electrophoretic device 1. Therefore, optical characteristics in light display and dark display of the electrophoretic device 1 are improved, and contrast is improved. Accordingly, a high-quality display unit with improved display characteristics is allowed to be provided.

### 4. EXAMPLES

Next, a description will be given in detail of examples of the embodiment of the present technology.

### Example 1

A display unit was fabricated with the use of black electrophoretic particles (for dark display) and a white porous layer (particle-containing fibrous structure) (for light display) by the following procedure.

(Preparation of Electrophoretic Particles)

First, 43 g of sodium hydroxide and 0.37 g of sodium silicate were dissolved in 43 g of water to obtain a solution D. Subsequently, 5 g of composite oxide fine particles (DAIPYROXIDE Color TM3550, available from Dainichiseika Color & Chemicals Mfg. Co., Ltd.) was added to the solution D, which was stirred (for 15 minutes). Thereafter, ultrasonic stirring (for 15 minutes at from 30 deg C to 35 deg C both inclusive) was performed. Next, the solution D was heated at 90 deg C. After that, 15 cm³ of vitriolic acid (0.22 mol/cm³) and 7.5 cm³ of an aqueous solution in which 6.5 mg of sodium silicate and 1.3 mg of sodium hydroxide were dissolved were dropped for 2 hours. Subsequently, after the solution D was cooled down (to room temperature), 1.8 cm³ of vitriolic acid (1 mol/cm³) was added thereto. Next, centrifugal separation (for 30 minutes at 3700 rpm) and decantation were performed. Thereafter, redispersion was performed with the use of ethanol, and centrifugal separation (for 30 minutes at 3500 rpm) and decantation were further performed twice. Subsequently, a mixed solution of 5 cm³ of ethanol and 0.5 cm³ of water was added to each bottle, ultrasonic stirring (for 1 hour) was performed, and thereby, a dispersion solution composed of silane coated composite oxide particles was prepared.

Next, 3 cm³ of water, 30 cm³ of ethanol, and 4 g of N-<3-(trimethoxysilyl)propyl>-N′-(4-vinylbenzil)ethylenediamine hydrochloride salt (40% methanol solution) were mixed, and the mixture was stirred (for 7 minutes). Thereafter, the resultant mixed solution was mixed with the dispersion solution, which was stirred (for 10 minutes), and was subjected to centrifugal separation (for 30 minutes at 3500 rpm). Subsequently, after decantation was performed, as washing operation, redispersion with the use of ethanol and centrifugal separation (for 30 minutes at 3500 rpm) were performed twice. Next, after the resultant was dried for 6 hours in reduced pressure environment (room temperature), the resultant was heated to 70 deg C and was dried for 2 hours. Next, the resultant was added with 50 cm³ of toluene to obtain a solution E. Thereafter, the resultant was stirred by a roll mill (for 12 hours). Subsequently, the solution E was added with 0.5 g of acrylic acid and 1.7 g of acrylic acid-2-ethylhexyl, and the resultant was stirred under nitrogen gas stream (for 20 minutes). Further, the solution E was heated to 50 deg C and was stirred (for 20 minutes). Thereafter, the solution E was added with a toluene solution (3 cm³, solution F) in which 0.01 g of AIBN was dissolved, was subsequently heated to 65 deg C, and was stirred for 1 hour. Next, the resultant was cooled down to room temperature, followed by addition of ethyl acetate and centrifugal separation (for 30 minutes at 3500 rpm). Subsequently, after decantation was performed, as washing operation, redispersion with the use of ethyl acetate and centrifugal separation (for 30 minutes at 3500 rpm) were performed three times. Subsequently, after the resultant was dried for 12 hours in reduced pressure environment (room temperature), the resultant was heated to 70 deg C, and was dried for 2 hours. Thereby, black electrophoretic particles (electrophoretic particles 20) configured of a polymer coated pigment were obtained.

(Preparation of Insulating Liquid)

Next, as an insulating liquid, 0.75% of N,N-dimethylpropane-1,3-diamine, 12-hydroxy octadecanoic acid, and methoxysulfonyloxymethane (Solsperse 17000, available from Lubrizol Co.), 5.0% of Sorbitan Trioleate (Span 85), 94% of an isoparaffin (IsoparG, available from Exxon Mobil Corporation) as a first component were mixed. In this example, as necessary, 0.2 g of the electrophoretic particles were added to 9.7 g of the insulating liquid, and the resultant was stirred (for 4 hours) by a homogenizer added with zirconia beads (0.03 mm diameter). Thereafter, centrifugal separation (for 5 minutes at 2000 rpm) was performed to remove zirconia beads. Further, centrifugal separation (for 5 minutes at 4000 rpm) was performed to prepare an insulating liquid in which the electrophoretic particles were dispersed.

(Preparation of Porous Layer)

Subsequently, 12 g of polyacrylonitrile (available from Aldrich Co., molar weight: 150000) as a formation material of a fibrous structure was dissolved to prepare spinning solutions (solutions A and B). Next, as the non-electrophoretic particles 32, for example, 40 g of titanium oxide (TITONE R-42 available from Sakai Chemical Industry Co., Ltd.) was added to part of the solution B, and the resultant was mixed by a beads mill to obtain a spinning solution (solution C). Subsequently, the solution A was thrown in a syringe, and 2 round trips of spinning were performed with the use of an electric field spinning apparatus (NANON, available from MECC Co., Ltd.) on a glass substrate on which a pixel electrode (ITO) in the shape of a predetermined pattern was formed (fibrous structure 31B). Next, the solution C was thrown in a syringe, and 15 round trips of spinning were performed as in the case of the solution A (fibrous structure 31A). In this example, as spinning conditions, electric field intensity was 28 kV, discharge rate was 0.5 cm³/min, spinning distance was 15 cm, and scanning rate was 20 mm/sec. Next, the glass substrate was dried for 12 hours in a vacuum oven (75 deg C) to form the porous layer 30 (the low-refractive index layer 30B and the high-refractive index layer 30A).

(Assembly of Display Unit)

First, an unnecessary fibrous structure 31A attached to a region where the pixel electrode 45 was not formed was removed from a glass substrate on which the pixel electrode 45 was formed. Thereafter, a PET film (being 20 micrometers thick) as a spacer was provided on a glass substrate on which the counter electrode 52 (ITO) was entirely formed. The glass substrate over which the pixel electrode 45 and the fibrous structures 31A and 31B were formed was layered on the spacer. It is to be noted that tracing was made with the use of a light cured resin (photosensitive resin Photoreck A-400, available from Sekisui Chemical Co., Ltd.) containing beads (outer diameter: 20 micrometers) in location on which the porous layer 30 was not layered. Finally, the insulating liquid in which the electrophoretic particles 20 were dispersed was injected between the two glass substrates. Thereafter, after the porous layer 30 was uniformly sandwiched between the pixel electrode 45 and the counter electrode 52 by pressing the entire body with a roller, the entire body was further pressed and compressed to fabricate a display unit (Example 1-1).

In addition thereto, Examples 2 to 7 in which the number of round trips of spinning, formation materials of fibrous structures, and the like were changed were fabricated. Table 1 summarizes configurations of Examples 1-1 to 1-7.

TABLE 1

| | The number of round trips of spinning | | | | |
|---|---|---|---|---|---|
| | Low-refractive | | Low-refractive | | |
| | index layer | | index layer | Material of fibrous structure | |
| | (side of display | High-refractive | (side of rear | Low-refractive | High-refractive |
| | surface) | index layer | surface) | index layer | index layer |
| Example | 2 | 15 | — | Polyacrylonitrile | |
| 1-1 | | | | | |
| Example | 4 | 15 | — | Polyacrylonitrile | |
| 1-2 | | | | | |
| Example | 8 | 15 | — | Polyacrylonitrile | |
| 1-3 | | | | | |
| Example | 4 | 15 | 4 | Polyacrylonitrile | |
| 1-4 | | | | | |
| Example | 4 | 15 | — | Polyacrylic acid | Polyacrylonitrile |
| 1-5 | | | | | |
| Example | 4 | 15 | — | Polymethyl | Polyacrylonitrile |
| 1-6 | | | | methacrylate | |
| Example | — | 15 | — | — | Polyacrylonitrile |
| 1-7 | | | | | |

As performances of the display units of Examples 1-1 to 1-7, black reflectance (%), white reflectance (%), and contrast ratios were examined. Table 2 summarizes results thereof. It is to be noted that upon examining the black reflectance and the white reflectance, with the use of a spectrophotometer (MCPD-700 available from Otsuka Electronics Co., Ltd.), each refractive index in a normal line direction of each substrate with respect to a referential diffusion plate was measured in ring lighting. In these examples, a voltage (drive voltage: 15 V) was applied for sufficient time in a state of white display to obtain a state of stable refractive index. In this state, the black reflectance and the white reflectance were measured. The contrast ratio was obtained by dividing the white reflectance by the black reflectance.

TABLE 2

| | Black | White | Contrast |
|---|---|---|---|
| | reflectance (%) | reflectance (%) | ratio |
| Example 1-1 | 1.8 | 47 | 26 |
| Example 1-2 | 1.5 | 48 | 32 |
| Example 1-3 | 1.0 | 52 | 52 |
| Example 1-4 | 1.2 | 50 | 42 |
| Example 1-5 | 1.6 | 47 | 29 |
| Example 1-6 | 1.8 | 47 | 26 |
| Example 1-7 | 2.2 | 45 | 20 |

Examples 1-1 and 1-7 (comparative example), in Example 1-1 in which the low-refractive index layer 30B was provided, the black reflectance was lowered (improved) and the contrast ratio was improved. In Examples 1-1 to 1-3, by increasing the number of round trips of spinning, that is, by increasing the film thickness, the black reflectance was lowered. Further, in Example 1-4 in which the low-refractive index layer 30B was provided on both the side of the display surface S and the side of the rear surface R of the high-refractive index layer 30A, the white reflectance was more improved than in Example 2 in which the number of round trips of spinning is the same as that of Example 1-4. One reason for this may be that, in this case, the electrophoretic particles 20 moved to the side of the pixel electrode 45 (the side of the rear surface) were contained in the low-refractive index layer 30B on the side of the rear surface, and were not left in the white high-refractive index layer 30A. It is to be noted that the lowered black reflectance resulted from the following state. That is, since the inner volume was increased due to the increased film thickness of the porous layer 30, the injection amount of the insulating liquid 10 was increased, and accordingly, the number of electrophoretic particles (black particles) was increased.

Further, from the results of Examples 1-5 and 1-6, it is found that the material of the fibrous structure configuring the low-refractive index layer 30B is not necessarily the same as that of the high-refractive index layer 30A, and these materials are not particularly limited, as long as the material configuring the low-refractive index layer 30B shows an approximately transparent state in the insulating liquid 10.

### Example 2

### Assembly of Display Unit

First, an unnecessary fibrous structure 31A attached to a region where the pixel electrode 45 of a glass substrate (drive substrate 40) was not formed was removed. Subsequently, a PET film (being 30 micrometers thick) as the spacer 60 was provided on a glass substrate (opposed substrate 50) on which the counter electrode 52 (ITO) was formed. Next, tracing was made with the use of a light cured resin (photosensitive resin Photoreck A-400, available from Sekisui Chemical Co., Ltd.) containing beads (outer diameter: 30 micrometers) in location on which the porous layer 30 of the opposed substrate 50 was not layered. Thereafter, the drive substrate 40 on which the porous layer 30 (the high refractive index layer 30A and the low refractive index layer 30B) was formed was layered thereon. Subsequently, the insulating liquid 10 in which the electrophoretic particles 20 were dispersed was injected between the drive substrate 40 and the opposed substrate 50. Thereafter, the porous layer 30 was uniformly sandwiched between the two substrates by pressing the entire body with a roller. Finally, the entire body was further pressed and compressed to fabricate a display unit (Example 1-1).

Six types of display units (Examples 2-1 to 2-6) were fabricated with the use of a method similar to that of the foregoing Example 1 except for the assembly of the display units. Black reflectance (%), white reflectance (%), and contrast ratios at a drive voltage of 15 V were measured. Further, respective contrast ratios 1 minute and 5 minutes after stopping application of voltage were measured.

Porous layers in Examples 2-3 and 2-4 were fabricated as follows. First, for example, 2.5 g of polyacrylonitrile (available from Aldrich Co., molar weight: 150000) was dissolved in 97.5 g of DMF to prepare a solution F. Next, a film being 200 nm thick was formed on the pixel electrode 45 and the counter electrode 52 by a spin coat method with the use of the solution C to obtain a low-refractive index layer 71B as a continuous film.

Table 3 summarizes configurations of Examples 2-1 to 2-6. Table 4 summarizes black reflectance (%), white reflectance (%), contrast ratios, and contrast ratios 1 minute and 5 minutes after stopping application of voltage in Examples 2-1 to 2-6.

TABLE 3

| | The number of round trips of spinning | | | | |
|---|---|---|---|---|---|
| | Low-refractive | | Low-refractive | | |
| | index layer | | index layer | Material of fibrous structure | |
| | (side of display | High-refractive | (side of rear | Low-refractive | High-refractive |
| | surface) | index layer | surface) | index layer | index layer |
| Example | 2 | 15 | 2 | Polyacrylonitrile | |
| 2-1 | | | | | |
| Example | 2 | 15 | 2 | KF1700 | Polyacrylonitrile |
| 2-2 | | | | | |
| Example | (200 nm) | 15 | (200 nm) | Polyacrylonitrile | |
| 2-3 | | | | | |
| Example | (200 nm) | 15 | (200 nm) | Polyacrylonitrile | |
| 2-4 | | | | | |
| Example | 2 | 15 | 2 | Polyethylene | Polyacrylonitrile |
| 2-5 | | | | oxide | |
| Example | — | 15 | — | — | Polyacrylonitrile |
| 2-6 | | | | | |

TABLE 4

| | Black | White | | 1 | 5 |
|---|---|---|---|---|---|
| | reflectance | reflectance | Contrast | minute | minutes |
| | (%) | (%) | ratio | after | after |
| Example 2-1 | 0.4 | 45 | 116 | 48 | 27 |
| Example 2-2 | 0.4 | 42 | 98 | 57 | 35 |
| Example 2-3 | 0.5 | 45 | 93 | 25 | 22 |
| Example 2-4 | 1.7 | 48 | 28 | 23 | 19 |
| Example 2-5 | 1.3 | 45 | 33 | 10 | 6 |
| Example 2-6 | 0.9 | 47 | 53 | 16 | 5 |

From Table 4, it was found as follows. That is, in Examples 2-1 to 2-4 in which polyacrylonitrile and KF1700 (polyvinylidene fluoride) were used, memory characteristics were improved compared to in Example 2-6 as a comparative example. Thus, even if the low-refractive index layer was the porous layer (the low-refractive index layer 30B) or the continuous film (the low-refractive index layer 71B), memory characteristics were improved. However, in the case where the porous low-refractive index layer 30B was used, the contrast ratio was improved and memory characteristics were further improved. Further, in Example 2-5 in which hydrophilic polyethylene oxide was used as a material of the low-refractive index layer 30B, almost no effect was obtained. Therefore, it was found that using, as a material of the low-refractive index layer 30B, a material having interaction with the electrophoretic particles 20 such as a material having opposite polarity is preferable.

While the present technology has been described with reference to the example embodiment and the modification, the present technology is not limited to the examples described in the foregoing embodiment and the like, and various modifications may be made. For example, application of the electrophoretic devices 1, 2A, 2B, 3, 4A, and 4B of the present technology is not limited to the display unit, and the electrophoretic devices 1, 2A, 2B, 3, 4A, and 4B of the present technology may be applied to other electronic apparatuses.

Furthermore, the technology encompasses any possible combination of some or all of the various embodiments described herein and incorporated herein.

It is possible to achieve at least the following configurations from the above-described example embodiments of the disclosure.

(1) An electrophoretic device, including:

an insulating liquid;

a plurality of electrophoretic particles provided in the insulating liquid; and

a porous layer provided in the insulating liquid and having a fibrous structure, the porous layer including a plurality of layers that have different refractive indices.

(2) The electrophoretic device according to (1), wherein the plurality of layers of the porous layer includes a porous high-refractive index layer and a low-refractive index layer, the low-refractive index layer being provided at least on a side of a display surface.

(3) The electrophoretic device according to (2), wherein the low-refractive index layer includes two low-refractive index layers, and the porous layer includes the two low-refractive index layers with the high-refractive index layer in between.

(4) The electrophoretic device according to (2) or (3), wherein the low-refractive index layer has a refractive index that is equal to or less than about 2.

(5) The electrophoretic device according to any one of (2) to (4), wherein the low-refractive index layer is a porous layer.

(6) The electrophoretic device according to any one of (2) to (4), wherein the low-refractive index layer is a continuous film.

(7) The electrophoretic device according to any one of (2) to (6), wherein the low-refractive index layer has a refractive index that is substantially equal to a refractive index of the insulating liquid.

(8) The electrophoretic device according to any one of (2) to (7), wherein a difference between a refractive index of the low-refractive index layer and a refractive index of the insulating liquid is equal to or less than about 0.5.

(9) The electrophoretic device according to any one of (1) to (8), wherein the fibrous structure includes a plurality of non-electrophoretic particles that have optical characteristics different from optical characteristics of the electrophoretic particles.

(10) The electrophoretic device according to (9), wherein the electrophoretic particles have higher affinity to the low-refractive index layer than to the fibrous structure that includes the non-electrophoretic particles.

(11) The electrophoretic device according to any one of (2) to (10), wherein the low-refractive index layer has a polarity that is different from a polarity of the electrophoretic particles.

(12) The electrophoretic device according to any one of (1) to (11), wherein the fibrous structure is configured of one of a polymer material and an inorganic material.

(13) The electrophoretic device according to any one of (1) to (12), wherein the fibrous structure includes fine pores, and the fine pores have an average pore diameter that ranges from about 0.01 micrometers to about 10 micrometers both inclusive.

(14) The electrophoretic device according to any one of (1) to (13), wherein the fibrous structure is formed by an electrostatic spinning method.

(15) The electrophoretic device according to any one of (1) to (14), wherein the fibrous structure is a nanofiber.

(16) The electrophoretic device according to any one of (9) to (15), wherein the electrophoretic particles and the non-electrophoretic particles are each formed of a material selected from a group consisting of an organic pigment, an inorganic pigment, a dye, a carbon material, a metal material, a metal oxide, glass, and a polymer material.

(17) The electrophoretic device according to any one of (9) to (16), wherein the optical characteristics of the non-electrophoretic particles are higher than the optical characteristics of the electrophoretic particles.

(18) A display unit with an electrophoretic device provided between a pair of base substances, one or both of the base substances being of a light transmissive type and each of the base substances being provided with an electrode, the electrophoretic device including:

an insulating liquid;
a plurality of electrophoretic particles provided in the insulating liquid; and
a porous layer provided in the insulating liquid and having a fibrous structure, the porous layer including a plurality of layers that have different refractive indices.
[1] A display apparatus, comprising:
a first layer, having a first index of refraction;
a second layer, having a second index of refraction, disposed adjacent to the first layer,
the second index of refraction being different than the first index of refraction; and a plurality of electrophoretic particles associated with at least one of the first layer and the second layer.
[2] The display apparatus of [1], wherein the plurality of electrophoretic particles are located within the at least one of the first layer and the second layer.
[3] The display apparatus of [2], wherein the plurality of electrophoretic particles are located within the second layer.
[4] The display apparatus of any one of [1] to [3], wherein the plurality of electrophoretic particles are movable within the at least one of the first layer and the second layer.
[5] The display apparatus of any one of [1] to [4] wherein the first index of refraction is greater than the second index of refraction.
[6] The display apparatus of any one of [1] to [5], further comprising a third layer having a third index of refraction, the first index of refraction being different than the third index of refraction, and the first layer located between the second layer and the third layer.
[7] The display apparatus of any one of [1] to [6], further comprising an insulating liquid, wherein the plurality of electrophoretic particles are dispersed within the insulating liquid.
[8] The display apparatus of [7], wherein an index of refraction of the insulating liquid is different than the first index of refraction.
[9] The display apparatus of [8], wherein the index of refraction of the insulating liquid is the same as the second index of refraction.
[10] The display apparatus of [8] or [9], wherein a difference between the index of refraction of the insulating liquid and the second index of refraction is less than 0.5.
[11] The display apparatus of any one of [7] to [10], wherein the second layer and the insulating liquid are transparent.
[12] The display apparatus of any one of [1] to [11], further comprising a functional group bonded to surfaces of the electrophoretic particles.
[13] The display apparatus of any one of [1] to [12], wherein a polarity of the first layer and a polarity of the plurality of electrophoretic particles are the same.
[14] The display apparatus of any one of [1] to [13], wherein the plurality of electrophoretic particles exhibit a dark display color.
[15] The display apparatus of any one of [1] to [14], wherein at least one of the first layer and the second layer is porous, having an average pore diameter of 0.01-10 microns.
[16] The display apparatus of any one of [1] to [15], wherein at least one of the first layer and the second layer is fibrous, having an average fiber diameter of 0.001-0.1 microns.
[17] A method of manufacturing a display apparatus, comprising:
positioning a first layer, having a first index of refraction, adjacent to a second layer, having a second index of refraction, the second index of refraction being different than the first index of refraction; and
positioning a plurality of electrophoretic particles within at least one of the first layer and the second layer.
[18] The method of [17], wherein the first index of refraction is greater than the second index of refraction.
[19] The method of [17] or [18], further comprising positioning a third layer, having a third index of refraction, adjacent to the first layer such that the first layer is located between the second layer and the third layer, the first index of refraction being different than the third index of refraction.
[20] The method of any one of [17] to [19], further comprising dispersing the plurality of electrophoretic particles within an insulating liquid having an index of refraction that is different from the first index of refraction.
[21] The method of [20], wherein the index of refraction of the insulating liquid and the second index of refraction are the same.
[22] The method of [20], wherein a difference between the index of refraction of the insulating liquid and the second index of refraction is less than 0.5.
[23] The method of [20], wherein the second layer and the insulating liquid are transparent.
[24] A method of operating a display apparatus, comprising:
applying an electric field to cause movement of a plurality of electrophoretic particles through a first layer, having a first index of refraction, toward a second layer, having a second index of refraction, the second index of refraction being different than the first index of refraction.
[25] The method of [24], wherein the first index of refraction is greater than the second index of refraction.
[26] The method of [24] or [25], wherein movement of the plurality of electrophoretic particles toward the second layer comprises maintaining a position of the plurality of electrophoretic particles within the second layer resulting in the second layer exhibiting a dark display color.

The present disclosure contains subject matter related to that disclosed in Japanese Priority Patent Application JP 2012-258543 filed in the Japan Patent Office on Nov. 27, 2012, the entire contents of which is hereby incorporated by reference.

It should be understood by those skilled in the art that various modifications, combinations, sub-combinations and alternations may occur depending on design requirements and other factors insofar as they are within the scope of the appended claims or the equivalents thereof.

### REFERENCE SIGNS LIST

1, 2A, 2B, 3, 4A, 4B Electrophoretic device
10 Insulating liquid
20 Electrophoretic particle
30 Porous layer
30A High-refractive index layer
30B Low-refractive index layer
31 (31A, 31B) Fibrous structure
32 Non-electrophoretic particle
33 Fine pore
40 Drive substrate
41, 51 Support base substance
42 TFT
43 Protective layer
44 Planarizing insulating layer
45 Pixel electrode
50 Opposed substrate
52 Counter electrode
60 Spacer

1. A display apparatus, comprising:
a first layer, having a first index of refraction;
a second layer, having a second index of refraction, disposed adjacent to the first layer, the second index of refraction being different than the first index of refraction; and
a plurality of electrophoretic particles associated with at least one of the first layer and the second layer.

2. The display apparatus of claim 1, wherein the plurality of electrophoretic particles are located within the at least one of the first layer and the second layer.

3. The display apparatus of claim 2, wherein the plurality of electrophoretic particles are located within the second layer.

4. The display apparatus of claim 1, wherein the plurality of electrophoretic particles are movable within the at least one of the first layer and the second layer.

5. The display apparatus of claim 1, wherein the first index of refraction is greater than the second index of refraction.

6. The display apparatus of claim 1, further comprising a third layer having a third index of refraction, the first index of refraction being different than the third index of refraction, and the first layer located between the second layer and the third layer.

7. The display apparatus of claim 1, further comprising an insulating liquid, wherein the plurality of electrophoretic particles are dispersed within the insulating liquid.

8. The display apparatus of claim 7, wherein an index of refraction of the insulating liquid is different than the first index of refraction.

9. The display apparatus of claim 8, wherein the index of refraction of the insulating liquid is the same as the second index of refraction.

10. The display apparatus of claim 8, wherein a difference between the index of refraction of the insulating liquid and the second index of refraction is less than 0.5.

11. The display apparatus of claim 7, wherein the second layer and the insulating liquid are transparent.

12. The display apparatus of claim 1, further comprising a functional group bonded to surfaces of the electrophoretic particles.

13. The display apparatus of claim 1, wherein a polarity of the first layer and a polarity of the plurality of electrophoretic particles are the same.

14. The display apparatus of claim 1, wherein the plurality of electrophoretic particles exhibit a dark display color.

15. The display apparatus of claim 1, wherein at least one of the first layer and the second layer is porous, having an average pore diameter of 0.01-10 microns.

16. The display apparatus of claim 1, wherein at least one of the first layer and the second layer is fibrous, having an average fiber diameter of 0.001-0.1 microns.

17. A method of manufacturing a display apparatus, comprising:
positioning a first layer, having a first index of refraction, adjacent to a second layer, having a second index of refraction, the second index of refraction being different than the first index of refraction; and
positioning a plurality of electrophoretic particles within at least one of the first layer and the second layer.

18. The method of claim 17, wherein the first index of refraction is greater than the second index of refraction.

19. The method of claim 17, further comprising positioning a third layer, having a third index of refraction, adjacent to the first layer such that the first layer is located between the second layer and the third layer, the first index of refraction being different than the third index of refraction.

20. The method of claim 17, further comprising dispersing the plurality of electrophoretic particles within an insulating liquid having an index of refraction that is different from the first index of refraction.

21. The method of claim 20, wherein the index of refraction of the insulating liquid and the second index of refraction are the same.

22. The method of claim 20, wherein a difference between the index of refraction of the insulating liquid and the second index of refraction is less than 0.5.

23. The method of claim 20, wherein the second layer and the insulating liquid are transparent.

24. A method of operating a display apparatus, comprising:
applying an electric field to cause movement of a plurality of electrophoretic particles through a first layer, having a first index of refraction, toward a second layer, having a second index of refraction, the second index of refraction being different than the first index of refraction.

25. The method of claim 24, wherein the first index of refraction is greater than the second index of refraction.

26. The method of claim 24, wherein movement of the plurality of electrophoretic particles toward the second layer comprises maintaining a position of the plurality of electrophoretic particles within the second layer resulting in the second layer exhibiting a dark display color.
